(19) United States
(12) Patent Application Publication
(10) Pub. No.: US 2015/0045931 A1
(43) Pub. Date: Feb. 12, 2015

(54) MACHINE CONTROL SYSTEM, MOTION CONTROLLER, AND CONNECTION DEVICE

(71) Applicant: Kabushiki Kaisha Yaskawa Denki, Kitakyushu-shi (JP)

(72) Inventor: Naoki MIZUNO, Kitakyushu-shi (JP)

(21) Appl. No.: 14/523,962

(22) Filed: Oct. 27, 2014

Related U.S. Application Data
(63) Continuation of application No. PCT/JP2012/061493, filed on Apr. 27, 2012.

(51) Int. Cl. G05B 19/042

(52) U.S. Cl. CPC G05B 19/0426; G05B 2219/32001
USPC 700/114

(57) ABSTRACT

Each of a plurality of connection devices in a machine control system includes: a motion program storage unit for storing a motion program to be executed by a motion controller to control the connection device; and a motion program transmission unit for transmitting the motion program stored in the motion program storage unit to the motion controller. The motion controller includes: a motion program acquisition unit for acquiring the motion program for controlling each of the plurality of connection devices connected for communication to the motion controller from the connection devices; and a control unit for controlling each of the connection devices by executing the motion program acquired by the motion program acquisition unit.

### INCORPORATION BY REFERENCE

The present disclosure contains subject matter related to that disclosed in International Application No. PCT/JP2012/061493 filed on Apr. 27, 2012, the entire contents of which are hereby incorporated by reference.

### BACKGROUND OF THE INVENTION

1. Field of the Invention

This disclosure relates to a machine control system, a motion controller, and a connection device, and more particularly, to a machine control system in which a motion controller controls a connection device by executing a motion program, and to a motion controller and a connection device to be used in the machine control system.

2. Description of the Related Art

A machine control system configured to execute a motion program with a motion controller and transmit a movement directive to a servo amplifier that is connected to the motion controller based on the motion program is known. A machine element, such as a servo motor, is connected to the servo amplifier. The servo amplifier operates the machine element based on a movement directive received from the motion controller. If a plurality of servo amplifiers are connected to the motion controller, a motion program suited to each servo amplifier and machine element is installed on the motion controller.

Hitherto, a motion program suited to the servo amplifiers and machine elements that are the target of a movement directive has been created by the person who intends to build the machine control system, or downloaded in advance via a communication network such as the Internet.

### SUMMARY OF THE INVENTION

A machine control system according to one embodiment of this disclosure includes: a motion controller; and a plurality of connection devices, each of which includes a machine element that is controllable and each of which is connected for communication to the motion controller.

Each of the plurality of connection devices includes: motion program storage for storing a motion program to be executed by the motion controller to control the connection device; and motion program transmitter for transmitting the motion program stored in the motion program storage to the motion controller.

Further, the motion controller includes: motion program receiver for receiving the motion program for controlling the each of the plurality of connection devices connected for communication to the motion controller from the each of the plurality of connection devices; and control unit for controlling the each of the plurality of connection devices by executing the motion program received by the motion program receiver.

### BRIEF DESCRIPTION OF THE DRAWINGS

FIG. 1 is an overall configuration diagram of a machine control system according to an embodiment of this disclosure.

FIG. 2 is a function block diagram of a motion controller.

FIG. 3 is a function block diagram of a servo amplifier.

FIG. 4 shows an example of properties.

FIG. 5 shows properties according to a first modified example of the embodiment.

FIG. 6 is an operation flow diagram of a motion controller according to the first modified example.

FIG. 7 shows properties according to a second modified example of the embodiment.

FIG. 8 is an operation flow diagram of a motion controller according to the second modified example.

### DESCRIPTION OF THE EMBODIMENTS

One embodiment of this disclosure is described below in more detail with reference to the drawings.

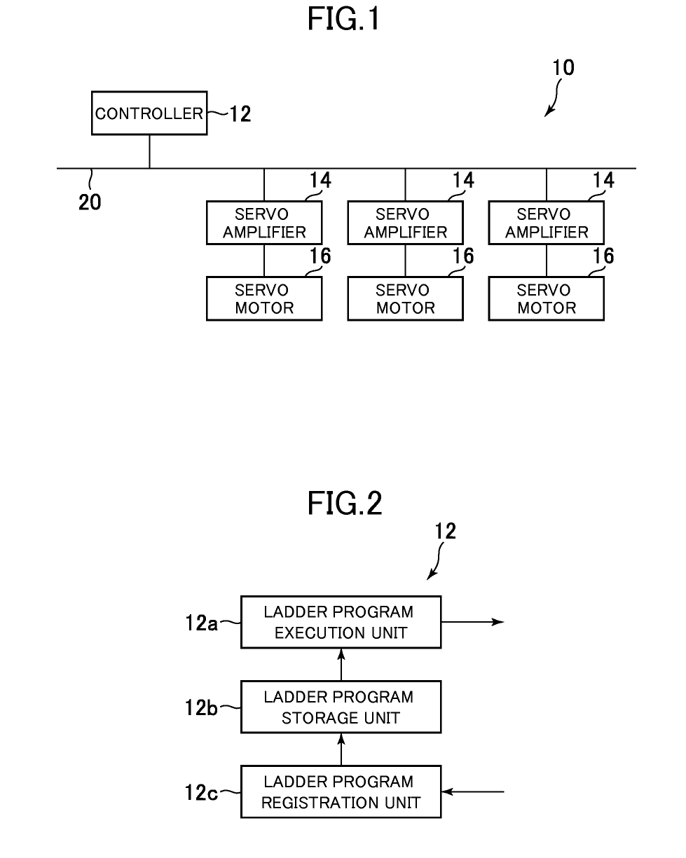

FIG. 1 is an overall configuration diagram of a machine control system according to the embodiment of this disclosure. A machine control system 10 illustrated in FIG. 1 includes a motion controller 12 and a plurality of external devices (connection devices) connected to a communication network 20. In this example, each of the external devices includes a servo amplifier 14 and a servo motor 16. The servo motor 16 included in each external device is, for example, a machine element that moves a positioning target along any one of an X-axis, a Y-axis, and a Z-axis, which are orthogonal to one another. The machine control system 10 is, for example, a three-axis positioning system. The motion controller 12 transmits a movement directive to each servo amplifier 14 via the communication network 20 by executing a ladder program, which is a motion program. The motion controller 12 is, for example, a programmable logic controller (PLC), which is an embodiment of a computer that is configured from a microprocessor and volatile and non-volatile memories. The servo amplifier 14 is also an embodiment of a computer that is configured from a microprocessor and volatile and non-volatile memories. Based on a movement directive received from the motion controller 12, the servo amplifier 14 executes control so that the servo motor 16 moves as instructed.

FIG. 2 is a function block diagram of the motion controller 12. Each of the function blocks illustrated in FIG. 2 is realized by executing a system program stored in the non-volatile memory of the motion controller 12. As illustrated in FIG. 2, the motion controller 12 functionally includes a ladder program execution unit 12a, a ladder program storage unit 12b, and a ladder program registration unit 12c. The ladder program storage unit 12b stores ladder programs and properties that are described later for controlling the machine control system 10. The ladder program execution unit 12a transmits movement directives to each servo amplifier 14 by executing the stored ladder program.

The ladder program registration unit 12c receives the ladder program and the properties from each servo amplifier 14 connected to the communication network 20, and stores those in the ladder program storage unit 12b. The ladder program registration unit 12c checks at regular time intervals whether an external device has been newly connected to the communication network 20. If an external device has been newly connected, the ladder program registration unit 12c quickly receives the ladder program and the properties from the new external device, and stores the received ladder program and properties in the ladder program storage unit 12b. The machine control system 10 may also be configured so that when an operating member (not shown), such as a button, included in the motion controller 12 is operated, the ladder programs and properties are received from every external device connected to the communication network 20 and stored in the ladder program storage unit 12b, or the ladder program and the properties are received from the newly connected external device and stored in the ladder program storage unit 12b.

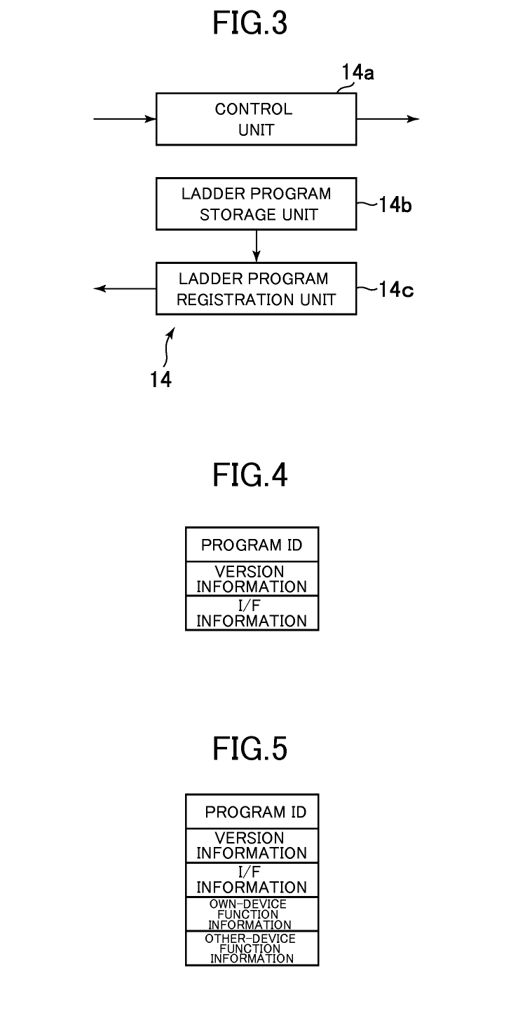

FIG. 3 is a function block diagram of the servo amplifier 14. Each of the function blocks illustrated in FIG. 3 is realized by executing a system program stored in the non-volatile memory of the servo amplifier 14 . As illustrated in FIG. 3, the servo amplifier 14 functionally includes a control unit 14a, a ladder program storage unit 14b, and a ladder program registration unit 14c. The ladder program storage unit 14b, which is configured from a non-volatile memory, stores a ladder program to be executed by the motion controller 12 for transmitting a movement directive to the servo amplifier 14 and the properties of the ladder program. FIG. 4 shows an example of those properties, which include a program ID that identifies the program, version information indicating the program version, and I/F information. The I/F information is used for data communication between the motion controller 12 and the servo amplifier 14 via the communication network 20. The I/F information includes a format of the data that is input and output at each communication port of the servo amplifier 14. The ladder program and properties may be stored in the ladder program storage unit 14b from an external computer. Alternatively, the ladder program and properties may be downloaded from a servo motor or a server on an information communication network, such as the Internet. The ladder program registration unit 14c transmits the ladder program and properties stored in the ladder program storage unit 14b to the motion controller 12. Further, the control unit 14a receives via the communication network 20 a movement directive transmitted to the servo amplifier 14 as a result of execution of the ladder program by the motion controller 12, and executes feedback control and other controls that cause the servo motor 16 to perform the instructed operation.

According to this embodiment, for example, when another external device, such as a pair of a servo amplifier 14 and a servo motor 16, is connected to the communication network 20, or when an operating member of the motion controller 12 has been operated, the ladder program for transmitting a movement directive to the servo amplifier 14 and the properties thereof are transmitted from the servo amplifier 14 to the motion controller 12. Consequently, each external device can be controlled to perform a desired operation without the need to perform troublesome installation work.

The ladder program storage unit 14b and the ladder program registration unit 14c are provided in the servo amplifier 14. A person who has a pair of a servo amplifier 14 and a servo motor 16 can use a computer to store an arbitrary ladder program and properties thereof in the ladder program storage unit 14b. If the pair of a servo amplifier 14 in which such an arbitrary ladder program and properties thereof are stored and a servomotor 16 are transferred to another person, even after being transferred, the operations intended by the transferor can be carried out. Consequently, an external device that performs a specific operation can be provided to another person.

The properties shown in FIG. 4 include a program ID and version information. Consequently, the machine control system 10 can be configured so that if it is determined based on a comparison by the ladder program registration unit 12c of the motion controller 12 that the properties of the ladder program already stored in the ladder program storage unit 12b and the properties received from a newly connected external device include the same program ID, the ladder program is newly received and overwritten in the ladder program storage unit 12b only when the version information included in the properties received from the newly connected external device indicates a newer version. In this manner, the latest version of a ladder program having the same program ID is preferentially executed by the motion controller 12.

FIG. 5 shows properties according to a first modified example of this embodiment. As shown in FIG. 5, in addition to a program ID, version information, and I/F information, the properties may also include own-device function information and other-device function information. Own-device function information is information specifying a function of the servo motor 16, which is a machine element included in the external device. For example, the own-device function information may be information indicating a direction for moving the positioning target, such as X, Y, and Z. Other-device function information is information specifying a function of a machine element included in at least one other external device that can be used with the external device. The other-device function information may also be information indicating a direction for moving the positioning target, such as X, Y, and Z. Further, information specifying the external device itself, such as a product code of the external device, can also be used as the own-device function information and the other-device function information.

For example, in this embodiment, the machine control system 10 moves the positioning target along an X-axis, a Y-axis, and a Z-axis, which are orthogonal to one another. The own-device function information about a first external device may be X, and the other-device function information may be Y and Z. Further, the own-device function information about a second external device may be Y, and the other-device function information may be X and Z. In addition, the own-device function information about a third external device may be Z, and the other-device function information may be X and Y.

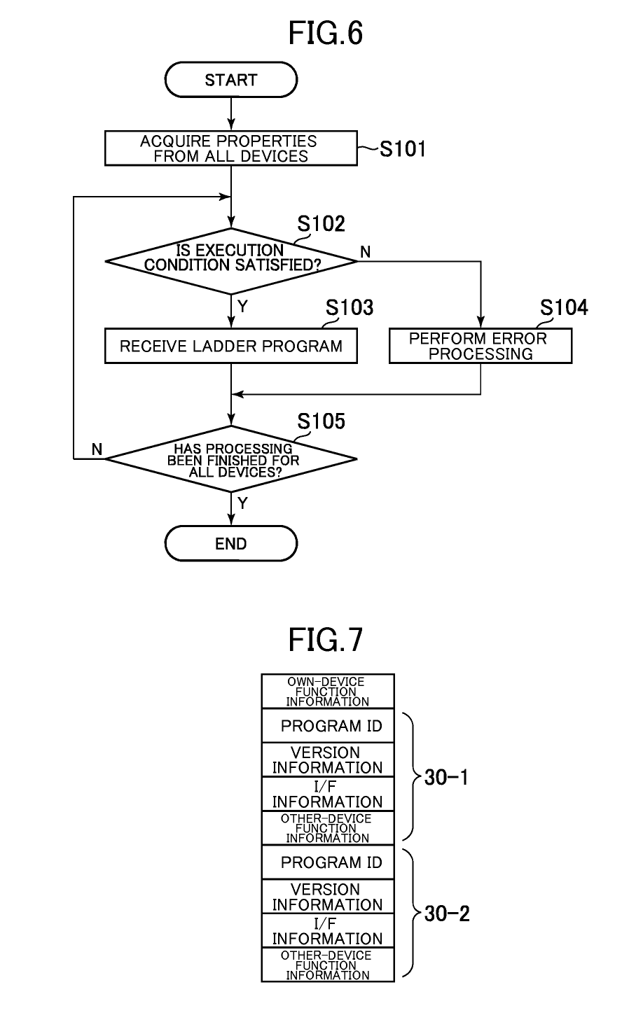

FIG. 6 is an operation flow diagram of the motion controller 12 according to the first modified example. As illustrated in FIG. 6, in the first modified example, the ladder program registration unit 12c receives the properties from all of the external devices connected to the communication network 20 (S101). Next, the ladder program registration unit 12c determines whether or not the ladder program stored in each external device can be executed (S102). Specifically, the ladder program registration unit 12c determines whether or not all of the elements of the other-device function information included in the properties received from each external device are included in the own-device function information included in the properties received from all of the other external devices. When all of the elements are included, the ladder program registration unit 12c receives the ladder program stored in that external device, and stores the received ladder program in the ladder program storage unit 12b (S103). On the other hand, when all of the elements are not included, the ladder program registration unit 12c executes error processing, such as displaying an error message on a display device (not shown), for example (S104) Then, the ladder program registration unit 12c performs the processing of Steps S102 to S104 on all of the external devices (S105).

The first modified example has the following advantages. Specifically, although a machine control system is configured from a combination of machine elements having specific functions, according to this modified example, a ladder program is installed on the motion controller 12 and executed only when the combination of machine elements has been correctly connected to the communication network 20. Consequently, if there is a mistake in the connection of the external devices, the problem of an unsuitable ladder program being installed on the motion controller 12 and executed can be avoided.

In a machine control system in which a plurality of external devices work together, it is common to control the plurality of external devices by one ladder program. In this case, the same ladder program may be stored in the ladder program storage units 14b of those external devices, or the motion controller 12 may receive the ladder program from any one of the external devices. FIG. 7 shows properties according to a second modified example of this embodiment. As shown in FIG. 7, in addition to own-device function information, the properties may include a plurality of information pairs 30-1 and 30-2 each configured from a program ID, version information, I/F information, and other-device function information. In this case, the ladder program storage unit 14b stores the same number of ladder programs as the number of information pairs, and each ladder program is linked with any one of the information pairs.

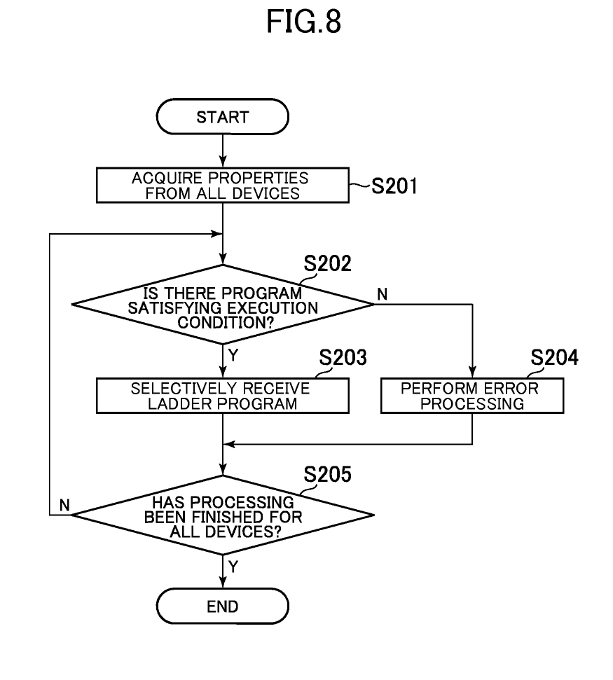

FIG. 8 is an operation flow diagram of the motion controller 12 according to the second modified example. As illustrated in FIG. 8, in the second modified example, the ladder program registration unit 12c receives the properties from all of the external devices connected to the communication network 20 (S201). Next, among the plurality of ladder programs stored in each of the external devices, the ladder program registration unit 12c selects one that satisfies an execution condition (S202). Specifically, the ladder program registration unit 12c determines whether or not, among the plurality of pieces of other-device function information included in each of the information pairs received from each of the external devices, there is a piece of other-device function information in which all of those elements are included in the own-device function information included in the properties received from all of the other external devices. When there is such a piece of other-device function information, the ladder program registration unit 12c receives the ladder program linked with that piece of other-device function information, and stores the received ladder program in the ladder program storage unit 12b (S203). On the other hand, when there is no such piece of other-device function information, the ladder program registration unit 12c executes error processing, such as displaying an error message on a display device (not shown), for example (S204). Then, the ladder program registration unit 12c performs the processing of Steps S202 to S204 on all of the external devices (S205).

The second modified example has the following advantages. Specifically, even for the same servo amplifier 14 and servo motor 16, the operation control to be performed is naturally different for a machine control system that is built by combining a predetermined external device group and for a different machine control system that is built by combining a different external device group. According to this modified example, a suitable ladder program can be installed on the motion controller 12 in consideration of what kind of external devices are to be combined and what kind of machine control system is to be built.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A machine control system, comprising:
a motion controller; and
a first and second connection devices, the first and second connection devices each includes a machine element that is controllable and is connected for communication to the motion controller,
the first and second connection devices each comprising:
motion program storage configured to store a motion program to be executed by the motion controller to control the first or second connection device; and
a motion program transmitter configured to transmit the motion program stored in the motion program storage to the motion controller,
the motion controller comprising:
a motion program receiver configured to receive the motion programs for controlling the first and second connection devices connected for communication to the motion controller; and
a control unit configured to control the first and second connection devices by executing the motion programs received by the motion program receiver.

2. The machine control system according to claim 1,
wherein the first connection device further comprises:
other-device function information storage configured to store other-device function information that specifies a function of the machine element included in the second connection device or a machine element included in a third connection device that is usable in combination with the first connection device,
wherein the second connection device further comprises:
own-device function information storage configured to store own-device function information that specifies a function of the machine element included in the second connection device,
wherein the motion program stored by the first connection device is configured to control the first connection device when used in combination with the second or third connection device that includes the machine element of the function specified by the other-device function information,
wherein the motion controller further comprises:
an information receiver configured to receive the other device function information from the first connection device and the own-device function information from the second connection device,
wherein the control unit executes the motion program sent from the first connection device based on the other-device function information received from the first connection device and the own-device function information received from the second connection device.

3. The machine control system according to claim 2,
wherein the other-device function information storage of the first connection device stores a plurality of pieces of the other-device function information,
wherein the motion program storage of the first connection device stores, in association with each of the plurality of pieces of the other-device function information, the motion program configured to control the first connection device when used in combination with the second or the third connection device that includes the machine element of the function specified by the piece of the other-device function information, and
wherein the control unit selects for the first connection devices, based on the own-device function information received from the second connection device, one piece of other-device function information from the plurality of pieces of the other-device function information received from the first connection device and executes the motion program that is associated with the selected piece of other-device function information.

4. The machine control system according to claim 1,
wherein the motion program storage stores the motion program together with version information about the motion program, and
wherein the control means executes a latest version of the motion program stored in any one of the first and second connection devices.

5. A motion controller to be used in a machine control system, the motion controller comprising:
a motion program receiver configured to receive a motion programs for controlling a first and second connection devices connected for communication to the motion controller from the first and second connection devices; and
a control unit configured to control the first and second connection devices by executing the motion programs received by the motion program receiver.

6. A connection device to be used in a machine control system, the connection device comprising:
a motion program storage configured to store a motion program to be executed by a motion controller included in the machine control system for controlling the connection device; and
a motion program transmitter configured to transmit the motion program stored in the motion program storage to the motion controller.
